(19) United States
(12) Patent Application Publication
(10) Pub. No.: US 2011/0045757 A1
(43) Pub. Date: Feb. 24, 2011

(54) Automobile smoke vent

(76) Inventors: Michael John Szwed, Des Plaines, IL (US); Steve Allen Ferrelli, Montgomery, IL (US)

Correspondence Address: Michael Szwed, 322 Columbia Ave., Des Plaines, IL, 60016, US

(21) Appl. No.: 12/802,596

(22) Filed: Jun. 8, 2010

Related U.S. Application Data
(63) Continuation of application No. 11/717,002, filed on Apr. 23, 2007, now abandoned.
(60) Provisional application No. 60/767,392, filed on Mar. 24, 2006.

(51) Int. Cl. B60J 1/20

(52) U.S. Cl. 454/131

(57) ABSTRACT

The Automobile Smoke Vent allows smoke from cigarettes, pipes, and cigars to exit the vehicle without letting conditioned air out (heated or cooled). It also allows the smoke to escape without letting rain or snow in. The invention allows minute amounts of condition air out along with the smoke. The adjustable swing arm is a dramatic help in limiting the size of the opening between the window and the invention. The swing arm is important, in the fact that it makes the invention adjustable to fit many different make and models of cars and trucks. The adjustable swing arm takes the guess work out of fitting the invention to car and trucks. When constructed of clear plastic the invention will not hinder the vision of the people in the vehicle. The invention can be used for advertising by various related manufactures, such as cigarette makers, cigar makers, pipe makers, radio stations etc. . . . It is compact and folds for easy storage.

### CROSS REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF INVENTION

1. Field of Invention

This invention relates to the venting of automobiles, specifically the venting of cigarette, cigar, and pipe smoke, by using an adjustable device adaptable to every vehicle.

2. BackGround-of Invention

The problem with most vehicles is that the cabins are subject to the build up of cigarette, cigar, and pipe smoke in addition to odors, fumes, and moisture. Most vehicles require that a window be opened in order to expel these things from the vehicle. However, while opening the vehicle window the outside temperature is allowed inside the cabin and conditioned air (heated or cooled) from inside the cabin is allowed to escape. Also, the outside elements, such as rain, snow, dirt, and dust are allowed to enter the vehicle through the opened window. Also, opening of the window causes great turbulence inside the cabin, especially at high speeds, causing noise and discomfort to the occupants of the vehicle. This invention will eliminate the above problem by removing unwanted smoke, odors, and moisture from the inside of the vehicle, while limiting the loss of the cabins preconditioned air and keeping the undesirable outside elements from entering the vehicle. It is done by creating a negative air flow, which pulls the unwanted contaminated air from the vehicle while protecting the interior of the cabin, and its occupants from the elements and temperatures. Inventors created several types of automobile vents in such a way as to allow to much air movement and to allow large volumes of air inside the cabin. They did not take into account the many different sizes and shapes of automobile windows. Some inventions have attempted to promote vehicle ventilation while limiting the air flux problem, but none as successfully as the present adjustable invention.

U.S. Pat. No. 4,685,718 to Lingg (1985) Discloses a weathershield having its top edge attached to retainer clip which is forced fitted into the window casing behind the rubber weather-strip that is typically is positioned within the casing; However these shields are model specific and protrude from the vehicle as an overhang of the window. Unlike the present invention. U.S. Pat. No. 5,284,377 to Krenciprock (1994) describes a vehicle ventilation device comprising a solid inverted y-shaped member which extends along the entire side glass edge creating no opening between the glass edge and run. Krenciprock uses two mounted cylindrical, vented protrusions for removing cigarette ashes. 1) Krenciprock's invention provides negligible smoke removal. 2) The device fails the universal adaptability test. The inventions shape would have to be tailored to fit specific window types. (size and shapes) Present invention is adaptable to all auto makes.

U.S. Pat. No. 5,525,105 to Deary (1996) Discloses a y-shaped apparatus interposed between an indexable glass edge of a vehicle and the glass run designed to receive the glass to promote vehicle ventilation and discourage high velocity air influxes which are common to opened windows while the vehicle is in motion; However the inventions 1) allows large amounts of outside air in while at a stop. 2) Deary's invention does not cover any of the downwards slope of the vehicles window. 3) The device fails the universal adaptability test; the inventions length would need to be adjustable to accommodate the various sizes of vehicle windows. 4) It uses rivets to construct invention unlike present invention which is one solid piece.

Several objects and advantages of the present invention are:
a) To provide a device that promotes the removal of smoke from a vehicle while discouraging large volumes of air from entering the vehicle.
b) To provide smoke ventilation at a stop without letting large amounts of unconditioned air or precipitation in the vehicle.
c) Creates a negative air flow from the cabin to the exterior of the vehicle. This creates the cleaning effects inside the cabin of the vehicle and greatly increases the quality of the air inside the cabin. Still more of an effect, is the interior of the vehicle will be healthier because the invention reduces the effect of second hand smoke to other occupants of the vehicle.
d) To provide improved elements and arrangements in a design which is; inexpensive, durable, transparent, adjustable, and easy to use and fit.
e) Fits a large number of makes and models of automobiles with the use of an adjustable swing arm. It is designed to fit manual and electrically controlled power side windows. It can be used on both the driver and passengers side windows.
f) Limits the size of the vent opening to inches thus limiting adverse affects of outside weather conditions. (Temperature, rain, and snow) Present invention covers more of the downwards angle of the window, using the adjustable swing arm. The adjustable swing arm is designed to follow the contours of many different makes and models of automobiles.
g) Uses no gaskets or seals, and uses present window seals from developing leaks between the vehicle window and the invention.
h) The material used to construct the main body and swing arm of the invention can be plastic, Plexiglas, aluminum, metal, wood, glass, or any other suitable material.

### SUMMARY

In accordance with the present invention Automobile Smoke Vent, A device to promote the removal of smoke from a vehicle while discouraging large volumes of air from entering the vehicle.

### DRAWINGS-FIGURES

FIG. 1: Is a perspective view of a vehicle utilizing The Automobile Smoke Vent Invention.

FIG. 2: Is an enlarge view of The Automobile Smoke Vent Invention.

FIG. 3: Is a side elevation of The Automobile Smoke Vent Invention in its collapsed state for storage.

FIG. 4: Is a side elevation view of The Automobile Smoke Vent Invention showing dimensions of the main body and illustrating the deployment of the swing arm.

FIG. 5: Is a front elevation view of The Automobile Smoke Vent Invention, and

FIG. 6: Is an enlarged perspective view of the tightening knob and bolt.

### DRAWING-REFERENCE NUMBERS

10. is the vehicle
20. is the Automobile Smoke Vent
25. is the swing arm deployment motion
30. is the car door frame top
35. is the smoke gap
40. is the car window
50. is the main body of the invention
60. is the swing arm
70. is the window channel
80. is the tongue
90. is the tightening knob
100. is an installation motion
110. is a bolt

### DRAWING-REFERENCE LETTERS

A. is a main body length dimension
B. is a main body height dimension
C. is a main body width dimension
E. is a main body tongue offset dimension
F. is a main body tongue thickness dimension
G. is a tongue height dimension
H. is a swing arm thickness dimension
J. is a main body window channel depth dimension at the rear
K. is a main body window channel depth dimension at the front

### DETAILED DESCRIPTION OF PREFERRED EMBODIMENT

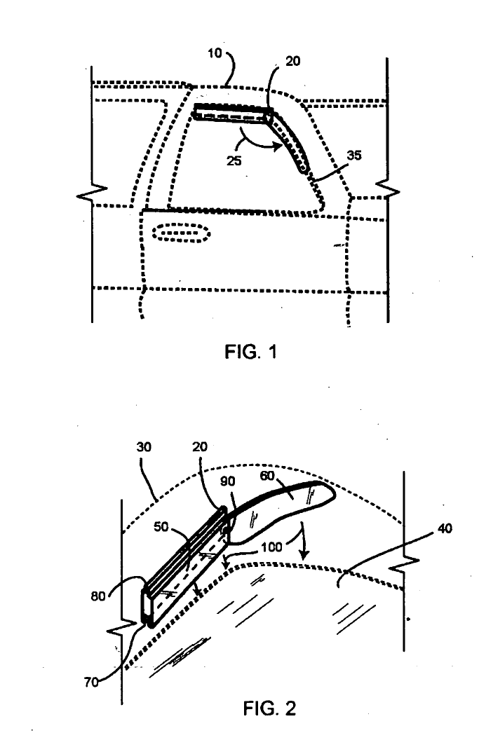

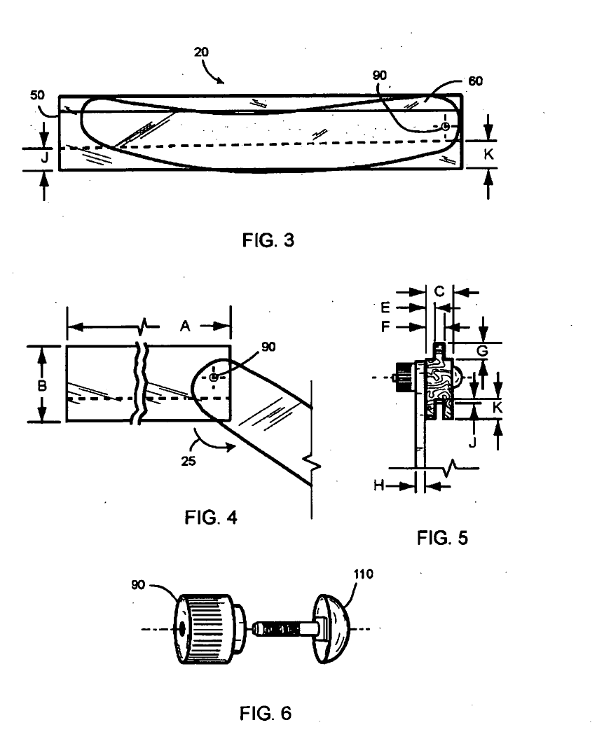

The present invention (20). relates to the ventilation of smoke from a vehicle (10). The embodiment of FIG. 1 shows the invention installed on the vehicle window (40). The invention (20) is placed on the edge of the window, between the vehicles (10) side window (40) and the door frame (30) or roof support of the vehicle (10). The swing arm (60) is then adjusted (25) to follow the contours of the sloping part of the window (40). While the swing arm (60) is held in place, the tightening knob (90) is tightened to hold the arm (60) at the desired angle (25). The window (40) is then raised up, leaving the invention (20) between the window (40) and the vehicle (10), all but eliminating the gap in the closed window (40). The only place for the vehicle cabin air to go is out a small gap (35) that is left between the invention (20) and the vehicle window (40). Smoke and other vehicle contaminates are drawn out a gap (35) between the window (40) and the invention (20). by negative air now from inside the vehicle (10) created by the motion of the vehicle. The volume of negative air flow is directly related to the speed of the vehicle (10). As the vehicles speed increases, so does the volume of air that is pulled from the vehicle. To remove the invention (20), the vehicle window (40) is lowered, the invention (20) is lifted off the window it was installed on, the tightening know (90) is loosened and the invention (20) is folded to the desired position for storage (FIG. 3). The window can then be operated in its normal way, until the invention is reinstalled. It is highly recommended that the invention (20) only be installed while the vehicle is stopped in a safe position. The invention will have a warning on it, “do not install while vehicle is in motion.” or something similar to that effect. When the vehicle moves forward it creates a vacuum or negative air flow which draws smoke through the gap (35) created by the invention (20) that is installed on the vehicle (10), because the invention (20) covers both the upper and angle openings, it leaves a small escape gap (35) that blocks the high velocity air and the noise associated with it. The decreased opening size also helps avoid letting rain, snow, cold, heat, or other outside elements from entering into the vehicle (10). Present invention (20) creates a vent window in autos where they have been designed out.

1. An Automobile smoke vent which is a frameless, gasket-less, constructed of plastic or other material; whereas it is fitted with an adjustable swing arm/barricade which makes it adaptable to fit any vehicle window; it is readily removable, portable, and compact.

2. The automobile smoke vent of claim 1, being frameless, makes fitting to different models of cars, trucks, vans, and suv's interchangeable.

3. The automobile smoke vent of claim 1 allows for one size fits all; no specific size manufacturing needed.

4. The automobile smoke vent of claim 1, being readily removable, requires no clips, screws, pins, or other fasteners to keep it in place.

5. The automobile smoke vent of claim 1 being portable is such that it can be moved, place and used from vehicle to vehicle, driver's side to passenger's side window.

6. The automobile smoke vent of claim 1 fits the contour of a sloped vehicle window blocking airflow and only allowing a small opening at the base.

7. The automobile smoke vent of claim 1 uses a tightening knob to adjust arm/barricade; can be reversed by taking knob off and switching arm to other side of embodiment for use on passenger side window.

8. The automobile smoke vent of claim 1 creates an opening which mimics a vent window, pivot/wing window which have been designed out by manufactures.
